(19) United States
(12) Patent Application Publication
(10) Pub. No.: US 2024/0183467 A1
(43) Pub. Date: Jun. 6, 2024

(54) LARGE-DIAMETER THIN-WALL SPIRAL WELDED PIPE AND METHOD FOR MANUFACTURING SAME

(71) Applicant: NANJING DADE STEEL PIPE CO., LTD., Nanjing (CN)

(72) Inventor: Fujun ZHAN, Nanjing (CN)

(73) Assignee: NANJING DADE STEEL PIPE CO., LTD., Nanjing (CN)

(21) Appl. No.: 18/407,558

(22) Filed: Jan. 9, 2024

Related U.S. Application Data
(63) Continuation of application No. PCT/CN2023/110720, filed on Aug. 2, 2023.

(30) Foreign Application Priority Data
Sep. 21, 2022 (CN) 202211150275.4
Sep. 21, 2022 (CN) 202222498548.6

(51) Int. Cl. F16L 9/18; B23K 31/02; B23K 101/06; B23K 101/10; B23K 103/04; F16L 9/16

(52) U.S. Cl. CPC F16L 9/18; B23K 31/027; F16L 9/165; B23K 2101/06; B23K 2101/10; B23K 2103/04

(57) ABSTRACT

It discloses a large-diameter thin-wall spiral welded pipe, which is formed by spirally roll-welding of a double-layer composite steel belt; the double-layer composite steel belt comprises a first steel belt layer and a second steel belt layer that are arranged with equal widths in an aligned manner, the first steel belt layer is a corrugated steel belt, the second steel belt layer is a flat steel belt, and both side edges and each wave trough of the first steel belt layer are welded to the second steel belt layer to form the double-layer composite steel belt; it further discloses a method for manufacturing the large-diameter thin-wall spiral welded pipe. According to the present invention, the corrugated steel pipe completely wraps the internal flat-wall steel pipe, so that the whole structure can bear an external load uniformly and cooperatively.

### CROSS-REFERENCE TO RELATED APPLICATIONS

This application is the U.S. continuation application of International Application No. PCT/CN2023/110720 filed on 2 Aug. 2023 which designated the U.S. and claims priority to Chinese Application Nos. CN202211150275.4 and CN202222498548.6 filed on 21 Sep. 2022, the entire contents of each of which are hereby incorporated by reference.

### TECHNICAL FIELD

The present invention relates to the technical field of welding of steel pipes, and in particular, to a large-diameter thin-wall spiral welded pipe and a method for manufacturing same.

### BACKGROUND

Current large-diameter steel pipes are mostly used as water supply pipes, and most of them are buried underground. Therefore, the steel pipe needs to be capable of bearing internal pressure from a medium circulating inside the pipe and further bearing the pressure of an external load, and to prevent a duck-egg shaped deformation caused by its own weight, and thus the wall thickness of the steel pipe needs to be large. In fact, the main purpose of the steel pipe is to convey fluid during which it should be capable of bearing the internal pressure, and to meet this requirement, the wall thickness of the steel pipe does not need to be too large. For example, for a water supply pipe with the diameter being 3 m, to meet the requirement of internal pressure, the wall thickness=PD/zk(σS)=(0.6 MPa*3000 mm)/(2*0.85*177.5 MPa)=5.96 mm. In the above formula, P is an internal pressure, D is an inner diameter of the pipe, σS is an allowable stress, and k is a welding seam coefficient (a spiral welded pipe). The allowable stress is two times of a safety coefficient in the above calculation. It can be seen from the above calculation that when the diameter is 3000 mm and the internal pressure is 0.6 MPa, the wall thickness of the steel pipe only needs to be 5.96 mm. However, in actual applications, in order to prevent the steel pipe from deforming caused by self-weight and by the external pressure when being buried, the wall thickness often needs to be increased. In actual engineering, for the water supply pipe with the diameter being 3 m and the internal pressure being 0.6 MPa, the wall thickness is 25 mm or more, causing a serious waste of materials. In fact, to prevent the steel pipe from deforming caused by self-weight and by the external pressure when being buried, a method of increasing sectional inertia moment of the pipe wall can be used. Although the method of increasing the wall thickness also belongs to the method of increasing the sectional inertia moment of the pipe wall, it only achieves an increase in a proportional multiple relationship rather than a geometric multiple relationship. In addition, when the wall thickness of a steel pipe with a super-large diameter is greater than 25 mm, the steel plate material from a steel factory cannot be delivered in a state of a steel roll, but only in a state of a single flat steel plate. Therefore, the machining manner of the steel pipe is to roll a single steel plate firstly and weld a straight butt seam to make a single-section steel pipe, and the length of the single-section steel pipe is generally 3 m; then a plurality of single-section steel pipes are butt-welded to make a pipe section of a standard length. This method has low production efficiency; and the force bearing effect of the straight welding seam is worse than that of a spiral welding seam, the welding seam coefficient is low, and thus the required thickness of the steel plate is larger than that of a spiral welded pipe of the same specification, causing a waste of materials.

In addition, in the prior art, there is a steel pipe as shown in FIG. 1, where annular reinforcing ribs are arranged outside an original steel pipe. There is also a steel pipe as shown in FIG. 2, where annular or spiral reinforcing rings are arranged outside an original steel pipe, and the section of the reinforcing ring is semi-circular. For the above-mentioned steel pipe with the reinforcing rings, the reinforcing rings cannot cover a whole surface of a pipe body. When the internal pressure is high, an uncovered part is prone to form a bulge, so the wall thickness still needs to be increased. When the external pressure is high, the external pressure directly acts on the pipe wall of the uncovered part, and the pipe wall may be deformed by internal deflection.

### SUMMARY

Objectives of the present invention: to overcome deficiencies described in the background, a first objective of the present invention is to disclose a large-diameter thin-wall spiral welded pipe; and a second objective is to disclose a method for manufacturing the above-mentioned large-diameter thin-wall spiral welded pipe.

Technical solutions: the present invention discloses a large-diameter thin-wall spiral welded pipe, being formed by spirally roll-welding of a double-layer composite steel belt, where the double-layer composite steel belt comprises a first steel belt layer and a second steel belt layer that are arranged with equal widths in an aligned manner, the first steel belt layer is a corrugated steel belt, the second steel belt layer is a flat steel belt, and both side edges and each wave trough of the first steel belt layer are welded to the second steel belt layer to form the double-layer composite steel belt.

Further, a groove is formed in an outer surface of the wave trough of the first steel belt layer and extends to the second steel belt layer to form a welding groove.

Further, during roll-welding, the first steel belt layer is located on an outer pipe wall of the welded pipe.

Further, a waveform of the first steel belt layer is a sine curve.

Further, the waveform of the first steel belt layer extends from one side edge to the other side edge of the steel belt.

Further, gaps between the first steel belt layer and the second steel belt layer are filled with concrete.

A method for manufacturing the above-mentioned large-diameter thin-wall spiral welded pipe comprises the following steps:
S1: obtaining a first steel belt by unwinding of a steel roll so as to be manufactured into a corrugated steel belt, i.e. a first steel belt layer, by a corrugated roller; obtaining a second steel belt by unwinding of the steel roll so as to form a second steel belt layer; and attaching the first steel belt layer and the second steel belt layer to form an initial composite steel belt;
S2: enabling the initial composite steel belt to enter a shaping roller shaft so as to be driven by the shaping roller shaft to enter a groove machining roller shaft, and cutting at a wave trough of the initial composite steel belt to form a welding groove at the wave trough of the first steel belt layer;
S3: performing three-in-one welding on the welding groove, and welding both side edges of the first steel belt layer and the second steel belt layer to form a double-layer composite steel belt; and
S4: pushing the double-layer composite steel belt into a spiral rolling machine by a delivery roller shaft for rolling, and welding a joint seam.

Further, the shaping roller shaft comprises an upper shaping roller and a lower shaping roller, a longitudinal section of the upper shaping roller is the same as and attached to a corrugated section of the initial composite steel belt, and the lower shaping roller is attached to a flat surface of the initial composite steel belt.

Further, the groove machining roller shaft comprises an upper machining roller and a lower machining roller, a longitudinal section of the upper machining roller is the same as and attached to the corrugated section of the initial composite steel belt, an end portion of a wave peak of the upper machining roller is provided with a machining blade, and a height of the machining blade is greater than a thickness of the first steel belt layer.

Further, the upper machining roller comprises an upper machining roller shaft, a split type cam, a split type concave wheel, and a blade wheel, the split type cam and the split type concave wheel are sleeved on the upper machining roller shaft and are spliced to form a roller surface structure having a longitudinal section the same as and attached to the corrugated section of the initial composite steel belt, the blade wheel is also sleeved on the upper machining roller shaft at a position of a wave peak of the roller surface structure, and a periphery of the blade wheel protrudes beyond a roller surface to form the machining blade.

Further, shapes of longitudinal sections of a pressing roller and a rolling roller of the spiral rolling machine are the same as a shape of a cross section of the double-layer composite steel belt.

Further, during cutting at the wave trough of the initial composite steel belt, a thermal cutting process is used, comprising plasma cutting, laser cutting or flame cutting.

Beneficial effects: compared with the prior art, advantages of the present invention are as follows:
1. the corrugated steel pipe completely wraps the internal flat-wall steel pipe, so that the whole structure can bear the external load uniformly and cooperatively;
2. the corrugated steel plate is cut into sections and then welded to the flat steel belt, so that the area of a section of a welding seam formed by welding between the corrugated steel plate and the flat steel belt is enlarged, and connection force is improved;
3. for the final pipe body, the sectional inertia moment of the pipe wall increases in geometrical multiple, and capability of bearing an external pressure is enhanced;
4. based on the steel pipe structure, a thickness of an inner wall and that of a corrugated pipe wall can be reduced, and steel material consumption can be reduced;
5. based on the steel pipe structure, a large-diameter steel pipe having a diameter of up to 6 m or more can be manufactured;
6. after filling gaps between the inner wall and the corrugated pipe wall, filling material can bear hoop stress, and strength is improved; and based on this, the thickness of the steel material can be appropriately reduced; and
7. the proposed groove machining roller shaft enables the outer diameters of the concave wheel, the cam, and the blade wheel to be adjusted flexibly based on actual production requirements, and thus the plate body can be cut accurately and quickly.

### BRIEF DESCRIPTION OF DRAWINGS

FIG. 1 is a structural diagram showing annular reinforcing ribs being arranged outside a steel pipe as described in the background;

FIG. 2 is a structural diagram showing annular reinforcing rings being arranged outside a steel pipe as described in the background;

FIG. 3 is a front view of a spiral welded pipe according to the present invention;

FIG. 4 is a structural diagram of a section of a double-layer composite steel belt according to the present invention;

FIG. 5 is a structural diagram of a section of an initial composite steel belt according to the present invention;

FIG. 6 is a structural diagram of a working section of a shaping roller shaft according to the present invention;

FIG. 7 is a structural diagram of a working section of a groove machining roller shaft according to the present invention;

FIG. 8 is a structural diagram of a section of an upper machining roller according to the present invention; and

FIG. 9 is a structural diagram of a welded double-layer composite steel belt according to the present invention.

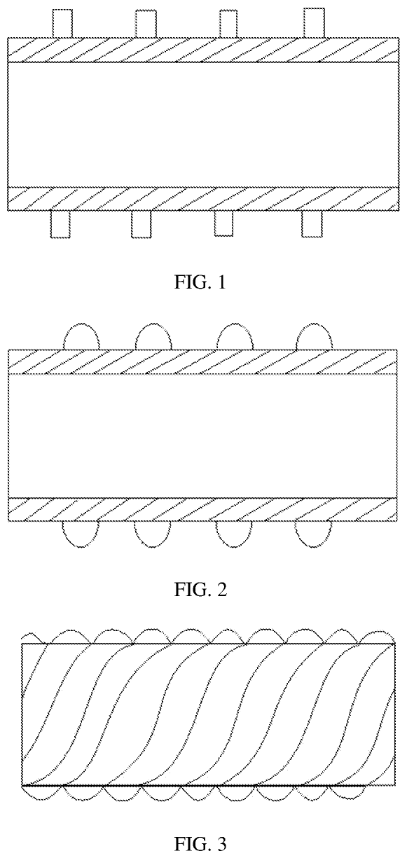

### DETAILED DESCRIPTION OF THE EMBODIMENTS

The present invention is further described in detail below in conjunction with accompanying drawings and specific embodiments.

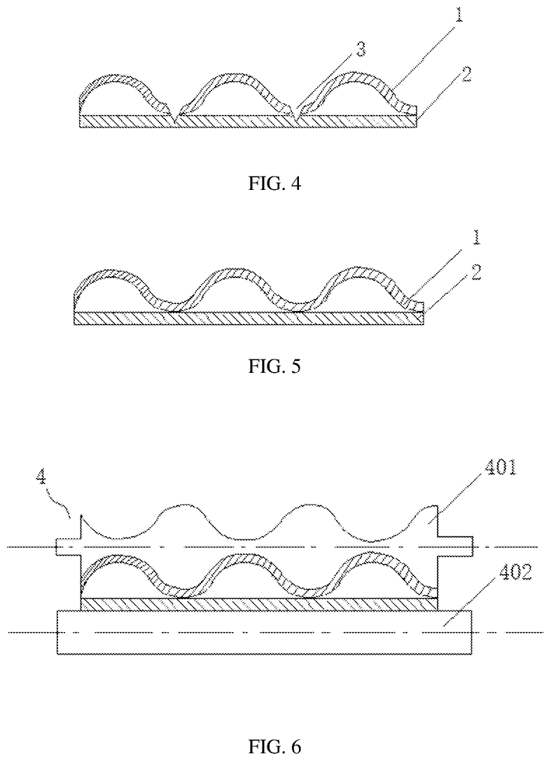

A large-diameter thin-wall spiral welded pipe as shown in FIG. 3 is formed by spirally roll-welding of a double-layer composite steel belt as shown in FIG. 4.

As shown in FIG. 4, the double-layer composite steel belt comprises a first steel belt layer 1 and a second steel belt layer 2 that are arranged with equal widths in an aligned manner, where the first steel belt layer 1 is a corrugated steel belt with a waveform being a sine curve which extends from one side edge to the other side edge of the steel belt. The second steel belt layer 2 is a flat steel belt, and both side edges and each wave trough of the first steel belt layer 1 are welded to the second steel belt layer 2 to form the double-layer composite steel belt.

A groove is formed in an outer surface of the wave trough of the first steel belt layer 1 and extends to the second steel belt layer 2 to form a welding groove 3, and during roll-welding, the first steel belt layer 1 is located on an outer pipe wall of the welded pipe. By performing three-in-one welding on the welding groove 3, the first steel belt layer 1 is fixed to the second steel belt layer 2.

Gaps between the first steel belt layer 1 and the second steel belt layer 2 are filled with a filler such as concrete so as to increase structural strength.

A method for manufacturing the large-diameter thin-wall spiral welded pipe comprises the following steps.

S1: A first steel belt is obtained by unwinding of a steel roll so as to be manufactured into a corrugated steel belt, i.e. a first steel belt layer 1, by a corrugated roller; a second steel belt is obtained by unwinding of the steel roll so as to form a second steel belt layer 2; and the first steel belt layer 1 and the second steel belt layer 2 are attached to form an initial composite steel belt, as shown in FIG. 5.

S2: A shaping roller shaft 4 is provided, where the shaping roller shaft 4 comprises an upper shaping roller 401 and a lower shaping roller 402, a longitudinal section of the upper shaping roller 401 is the same as and attached to a corrugated section of the initial composite steel belt, and the lower shaping roller 402 is attached to a flat surface of the initial composite steel belt, as shown in FIG. 6.

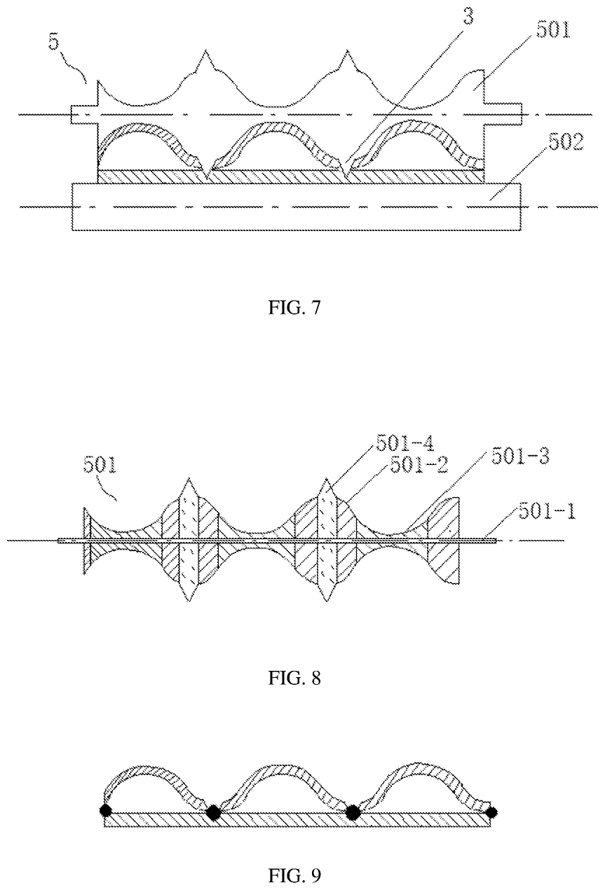

As shown in FIG. 7 and FIG. 8, a groove machining roller shaft 5 is provided, where the groove machining roller shaft 5 comprises an upper machining roller 501 and a lower machining roller 502, a longitudinal section of the upper machining roller 501 is the same as and attached to the corrugated section of the initial composite steel belt, an end portion of a wave peak of the upper machining roller 501 is provided with a machining blade 503, and a height of the machining blade 503 is greater than a thickness of the first steel belt layer 1, where the upper machining roller 501 comprises an upper machining roller shaft 501-1, a split type cam 501-2, a split type concave wheel 501-3, and a blade wheel 501-4, the split type cam 501-2 and the split type concave wheel 501-3 are sleeved on the upper machining roller shaft 501-1, and are spliced to form a roller surface structure having a longitudinal section the same as and attached to the corrugated section of the initial composite steel belt, the blade wheel 501-4 is also sleeved on the upper machining roller shaft 501-1 at a position of a wave peak of the roller surface structure, and a periphery of the blade wheel protrudes beyond a roller surface to form the machining blade 503. The split type cam 501-2, the split type concave wheel 501-3, and the blade wheel 501-4 may be axially and circumferentially fixed to the upper machining roller shaft 501-1 through shaft keys.

During operation, the initial composite steel belt enters the shaping roller shaft 4, and is driven by the shaping roller shaft 4 to enter a groove machining roller shaft 5; and cutting is performed at a wave trough of the initial composite steel belt to form a welding groove 3 extending from the wave trough of the first steel belt layer 1 to the second steel belt layer 2, and during cutting, a thermal cutting process is used, comprising plasma cutting, laser cutting, or flame cutting, etc.

S3: Three-in-one welding is performed on the welding groove 3, and both side edges of the first steel belt layer 1 and the second steel belt layer 2 are welded to form a double-layer composite steel belt, as shown in FIG. 9.

S4: The double-layer composite steel belt is pushed into a spiral rolling machine by a delivery roller shaft for rolling, where shapes of longitudinal sections of a pressing roller and a rolling roller of the spiral rolling machine are the same as a shape of a cross section of the double-layer composite steel belt. Finally, a joint seam is welded to obtain the spiral welded pipe as shown in FIG. 3.

What is claimed is:

1. A large-diameter thin-wall spiral welded pipe, being formed by spirally roll-welding of a double-layer composite steel belt, wherein the double-layer composite steel belt comprises a first steel belt layer (1) and a second steel belt layer (2) that are arranged with equal widths in an aligned manner, the first steel belt layer (1) is a corrugated steel belt, the second steel belt layer (2) is a flat steel belt, and both side edges and each wave trough of the first steel belt layer (1) are welded to the second steel belt layer (2) to form the double-layer composite steel belt.

2. The large-diameter thin-wall spiral welded pipe according to claim 1, wherein a groove is formed in an outer surface of the wave trough of the first steel belt layer (1) and extends to the second steel belt layer (2) to form a welding groove (3).

3. The large-diameter thin-wall spiral welded pipe according to claim 1, wherein during roll-welding, the first steel belt layer (1) is located on an outer pipe wall of the welded pipe.

4. The large-diameter thin-wall spiral welded pipe according to claim 1, wherein a waveform of the first steel belt layer (1) is a sine curve.

5. The large-diameter thin-wall spiral welded pipe according to claim 1, wherein the waveform of the first steel belt layer (1) extends from one side edge to the other side edge of the steel belt.

6. The large-diameter thin-wall spiral welded pipe according to claim 1, wherein gaps between the first steel belt layer (1) and the second steel belt layer (2) are filled with concrete.

7. A method for manufacturing the large-diameter thin-wall spiral welded pipe according to claim 1, comprising the following steps:
S1: obtaining a first steel belt by unwinding of a steel roll so as to be manufactured into a corrugated steel belt, i.e. a first steel belt layer (1), by a corrugated roller; obtaining a second steel belt by unwinding of the steel roll so as to form a second steel belt layer (2); and attaching the first steel belt layer (1) and the second steel belt layer (2) to form an initial composite steel belt;
S2: enabling the initial composite steel belt to enter a shaping roller shaft (4) so as to be driven by the shaping roller shaft (4) to enter a groove machining roller shaft (5), and cutting at a wave trough of the initial composite steel belt to form a welding groove (3) at the wave trough of the first steel belt layer (1);
S3: performing three-in-one welding on the welding groove (3), and welding both side edges of the first steel belt layer (1) and the second steel belt layer (2) to form a double-layer composite steel belt; and
S4: pushing the double-layer composite steel belt into a spiral rolling machine by a delivery roller shaft for rolling, and welding a joint seam.

8. The method for manufacturing the large-diameter thin-wall spiral welded pipe according to claim 7, wherein the shaping roller shaft (4) comprises an upper shaping roller (401) and a lower shaping roller (402), a longitudinal section of the upper shaping roller (401) is the same as and attached to a corrugated section of the initial composite steel belt, and the lower shaping roller (402) is attached to a flat surface of the initial composite steel belt.

9. The method for manufacturing the large-diameter thin-wall spiral welded pipe according to claim 7, wherein the groove machining roller shaft (5) comprises an upper machining roller (501) and a lower machining roller (502), a longitudinal section of the upper machining roller (501) is the same as and attached to the corrugated section of the initial composite steel belt, an end portion of a wave peak of the upper machining roller (501) is provided with a machining blade (503), and a height of the machining blade (503) is greater than a thickness of the first steel belt layer (1).

10. The method for manufacturing the large-diameter thin-wall spiral welded pipe according to claim 9, wherein the upper machining roller (501) comprises an upper machining roller shaft (501-1), a split type cam (501-2), a split type concave wheel (501-3), and a blade wheel (501-4), the split type cam (501-2) and the split type concave wheel (501-3) are sleeved on the upper machining roller shaft (501-1) and are spliced to form a roller surface structure having a longitudinal section the same as and attached to the corrugated section of the initial composite steel belt, the blade wheel (501-4) is also sleeved on the upper machining roller shaft (501-1) at a position of a wave peak of the roller surface structure, and a periphery of the blade wheel protrudes beyond a roller surface to form the machining blade (503).

11. The method for manufacturing the large-diameter thin-wall spiral welded pipe according to claim 7, wherein shapes of longitudinal sections of a pressing roller and a rolling roller of the spiral rolling machine are the same as a shape of a cross section of the double-layer composite steel belt.

12. The method for manufacturing the large-diameter thin-wall spiral welded pipe according to claim 7, wherein during cutting at the wave trough of the initial composite steel belt, a thermal cutting process is used, comprising plasma cutting, laser cutting or flame cutting.
